(19) United States
(12) Patent Application Publication
(10) Pub. No.: US 2005/0160024 A1
(43) Pub. Date: Jul. 21, 2005

(54) Automated system for aggregated price discovery and electronic trading of linked cash/cash equivalent and their derivative asset packages

(75) Inventors: James Robert Soderborg, San Francisco, CA (US); Chris Dobosz, San Francisco, CA (US); Gary Schick, San Francisco, CA (US); John Katovich, Oakland, CA (US); Cathy Fabiszak, Madison, WI (US)

Correspondence Address: MAYER, FORTKORT & WILLIAMS, PC, 251 NORTH AVENUE WEST, 2ND FLOOR, WESTFIELD, NJ, 07090, US

(73) Assignee: Side By Side Trading, Inc., San Francisco, CA (US)

(21) Appl. No.: 10/457,792

(22) Filed: Jun. 9, 2003

Related U.S. Application Data
(60) Provisional application No. 60/387,209, filed on Jun. 7, 2002.

(51) Int. Cl. G06F 17/60

(52) U.S. Cl. 705/37

(57) ABSTRACT

An electronic system for aggregated pricing of linked multi-leg (e.g., equity/option and option/option) asset packages with an additional link to an automated broker system for trading the linked asset packages are disclosed. The invention provides methodology and apparatus to electronically produce aggregated price quotes for packages of instruments designed to represent traditional trading strategies involving cash and their derivatives (e.g., stock and equity options). The system develops packages according to specified strategies, and prices the packages based on the national best bid and offer (NBBO) or direct input from participating market makers and investors. The packages are designed for easy understanding by traditional investors and designed for trading through a single order. These packages are desirable over separately trading the asset and its derivative (e.g., equity and option) instruments because they transfer market volatility risk from the investor to the institution by requiring market makers to agree to the aggregated price of the package prior to executing any trades. Certain linked packages, such as most stocks and options, cannot be traded together on a single floor of an exchange due to restrictions by the Securities and Exchange Commission (SEC) regarding side-by-side trading and integrated market making of most stocks and options. This invention provides an electronic process for synthetic side-by-side trading across separate trading locations (e.g., equity and option exchanges and within the existing rules of the SEC). The electronic process follows traditional rules regarding the manual handling of combination orders involving multiple asset types. The process significantly improves efficiency over manual handling resulting in a system that is scalable to high trade volumes.

### STATEMENT OF RELATED APPLICATION

This application claims the benefit of priority to U.S. Provisional Patent Application Ser. No. 60/387,209, filed Jun. 7, 2002, entitled “Automated System For Aggregated Price Discovery And Electronic Trading Of Linked Equity And Equity Option Asset Packages.”

### FIELD OF THE INVENTION

The present invention relates generally to methods and apparatuses for trading instruments, and more particularly to a method and apparatus for trading instruments electronically.

### COPYRIGHT NOTICE

A portion of the disclosure of this patent document contains material, which is subject to copyright protection. The copyright owner has no objection to the facsimile reproduction by anyone of the patent document or patent disclosure, as it appears in the Patent and Trademark Office, patent file or records, but otherwise reserves all copyright rights whatsoever.

### BACKGROUND

The trading of a separate underlying asset instruments (e.g., cash or cash equivalent) and its derivatives are used in a variety of investment strategies designed to hedge investment positions. The separate instruments that are traded in combination via a linked process to effect a strategy position are referred to as ‘legs’. In establishing a strategy of an asset instrument, with single or multiple derivatives linked, an investor implementing a standardized package can order the buying and selling of legs individually or, for example, in the case of packages that trade at stock and options exchanges, the investor can send the combination of legs to a single broker as a combination order to fill all or none of the legs with regard to each combination. The advantage of submitting a combination order is that the investor does not risk missing a leg of the strategy due to volatility in the market in which the instruments are being traded. For example, on an options exchange, an investor may purchase the option portion of the strategy only to find that the equities market has moved away from the desired price of the equity. Thus, the investor may find himself in a position of risk rather than a hedged position. By submitting a combination order the investor is ensured that he will either complete all legs of the trade or none at all, for each contract submitted.

When a broker at, for instance, a trading exchange, receives a combination order from a customer, the broker attempts to complete the entire package with a market maker or specialist who agrees to take the other side of all legs of the order. The Securities and Exchange Commission (SEC) has, however, established specific restrictions regarding the market maker or specialist that desires to quote and trade both equities and options on the same floor, due mainly to the obvious opportunities such additional information would provide to any one market maker. Thus, brokers who handle combination orders containing both instruments must usually cross equity legs of the order on a separate exchange from where the option legs are traded. Typically, the broker will enter the options pit looking for a willing market maker. Upon receiving an agreement with the options market maker the broker will then cross the stock on a remote equities exchange representing both the buyer and seller (i.e., the customer and the options market maker). The broker will then post the options trade with the market maker at the previously agreed upon price. Finally, the broker will report back to the investor either a fill or no fill on the number of contracts completed for all legs of the combination order.

But even if such restrictions did not apply and a broker could trade the separate legs at one location, there is no mechanism to ensure a best bid an doffer are obtained for each leg of the combination order.

When the broker enters the options trading pit, the broker represents the client and thus is expected to remain in the pit as the client's representative until the trade is complete. This manual handling of the order is not scalable to large volumes of combination orders either in time or cost. The entire trade may take several minutes during which time the broker cannot handle another combination order in a different pit.

The present invention is therefore directed to the problem of developing a method and apparatus for performing high-volume, side-by-side electronic trading that takes the place of several functions of, for instance, the floor broker at a trading exchange, and interacts electronically with those making markets at separate locations, especially where restrictions occur, such as market makers on both the equities and options exchanges. The invention is also directed to the problem of developing a method and apparatus for facilitating efficient price discovery by combining multiple functions, for searching for the best price at multiple locations at once, and for executing a combination package almost simultaneously.

### SUMMARY OF THE INVENTION

The present invention solves these and other problems by providing inter alia an electronic system for performing high-volume side-by-side electronic trading that takes the place of several functions of a broker and interacts electronically with those making markets in both the underlying instrument and its derivative (e.g., such as the market makers on both the equities and options exchanges), along with several necessary underlying processes.

The present invention introduces new financial products for trading, for example, in the financial marketplaces. The new products package linked cash and their derivatives, for example, existing equity and equity option instruments, into a single price quote and allow investors to trade all of the packaged instruments through a single order, in essence embedding the derivative into the cash. The present invention addresses all aspects of the product necessary to enable trading of these new linked or embedded financial products. These aspects include calculating and disseminating price quotes for the packages, developing a methodology as to how brokers can incorporate the new products into their offerings, and working with investors to develop an apparatus for electronic trading and clearing of these new products on existing exchanges.

The packages, called “linked asset packages,” created by one aspect of the present invention represent standard professional trading strategies, such as any typical cash and derivatives market (e.g., married put and covered writes that include stock and options). The present invention has been developed to address the lack of methodology and apparatus in the current marketplace for pricing, quoting, buying and selling of linked strategies as a single package, while allowing for the continued separation of trading locations to execute. Currently, investors must execute multiple orders to establish the same strategies offered by the present invention or send inefficient combination orders to, for example, a floor broker. In executing multiple orders, the investor assumes a risk that they may not acquire or dispose of all legs of a strategy quickly enough if the market moves rapidly away from them.

The present invention eliminates this risk by ensuring that an investor trades either all or none of the legs of a strategy. And if all legs are traded, the trades are executed much more efficiently by automating an otherwise manual, multi-step process. To accomplish this, the embodiments of the present invention partly replace a floor broker with an automated electronic system.

The embodiments herein address all aspects necessary to create, transact, and execute orders of these strategies. The detailed summary discusses each of these elements in this order. Specifically, the methodology and apparatus can be broken down into three generic sections:

1. A methodology and apparatus for combining cash and derivatives (e.g., equity and equity option) price quotes into a single packaged quote, which is disseminated to the investment community through both existing and newly developed channels.

2. A methodology for offering linked asset packages to investors, maintaining the assets in a linked capacity within an investor's account; rules governing the trading of the linked assets; rules governing the splitting of linked assets; methods for replacing expiring assets to maintain a valid linked asset package; and methods for obtaining increased financial leverage as a result of the linking of the assets.

3. A methodology and apparatus for trading of linked asset packages by an automated electronic system (e.g., trading of stocks and options currently associated with the floor of a stock and options exchange); dividing a linked asset order into individual instrument orders; execution of orders; packaging of execution reports for all legs of the linked asset trade into a single report; transmission of the combined execution report to the originating broker; and reporting trades to the appropriate clearing bodies.

### BRIEF DESCRIPTION OF THE DRAWINGS

FIG. 1 depicts a flow diagram of an existing manual process required to execute, for example, a combination order containing both equity and equity option instruments on the floor of an options exchange.

FIG. 2 depicts a flow diagram of an exemplary embodiment of a method according to one aspect of the present invention for quoting, as an example, an aggregated price for packages of equity and equity option instruments.

FIG. 3 depicts an exemplary embodiment of price quotes generated by an exemplary embodiment of a method according to another aspect of the present invention for packages of instruments (e.g., equity and equity options).

FIG. 4 depicts a block diagram of an exemplary embodiment of a method for buying and selling linked asset packages from the perspective of an investor according to yet another aspect of the present invention.

FIG. 5 depicts an exemplary embodiment of an investor balance sheet showing linked asset packages according to still another aspect of the present invention.

FIG. 6 depicts a flow diagram of an exemplary embodiment of a method for replacing an expiring instrument (e.g., an option leg of a linked asset package) using a linked asset (e.g., an option spread order) according to yet another aspect of the present invention.

FIG. 7 depicts a flow diagram of and example of a method according to yet another aspect of the present invention for executing a trade of a linked asset package of equity and equity option instruments.

FIG. 8 depicts an exemplary embodiment of an electronic message format for submitting a linked asset trade order to a trading apparatus according to still another aspect of the present invention.

FIG. 9 depicts an exemplary embodiment of a method according to still another aspect of the present invention for pricing asset legs for linked asset packages containing both equity and equity option assets.

FIGS. 10A-C depict an exemplary embodiment of an execution report for a linked asset trade containing both equity and equity option assets according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention comprises the packaging of linked instruments, and the directing of such packaged assets to an automated broker system for price discovery, generation of quotes, and for trading such packages of instruments that can be linked together. These linked instruments may include any underlying asset that has a derivative instrument connected to it, such as any cash and derivative and, as an example, packages of stock (equity) and stock (equity) options instruments via a single order.

The present invention encompasses the methods and apparatus for creating, trading, and tracking of linked assets. First, discussed are the methods and apparatus for selecting assets to be linked, aggregated price discovery of the linked assets, and the distribution of data specific to the linked assets. Second, the methodology for market participants to identify, trade, and track linked assets is discussed. Third, the methods and apparatus for trading, clearing, and reporting of linked assets are discussed in detail.

For purposes of this invention, and as used herein, “asset” or “assets” refers to any tradable security or commodity or item of value, in which there exits a market or creation of a market however small for trading of any security or commodity or item of value. Examples include, but are not limited to: securities, equities, linked spreads (e.g., linked option spreads), bonds, futures, mutual funds, hedge funds, derivatives, currencies (both national and foreign), commodities, insurance contracts, mortgages, high yield debt, foreign debt, convertible debt, notes, pollution rights, development rights, leases, loans, real estate investment trusts, indexes (e.g., ETFs and iShares), single stock futures, etc. “Assets” also refers to any collection of assets whether singly packaged or bundled.

Although the computer-based system of the present invention can be used for any such asset or combination of asset, for brevity, the discussion herein relates primarily to its use and connection with tradable instruments or securities, and particularly to cash and derivatives, and equities and equity options.

Method and Apparatus for Linking of Assets

The present invention provides a methodology and apparatus for linking related (e.g., equity and equity option) assets and quoting an aggregated price for the linked assets. The methodology selects and packages assets (e.g., equities and equity options) to represent commonly used trading strategies, such as, for example, the “married put” and “covered write.” The apparatus then assigns an aggregated price to the packages and distributes the price quotes to the markets where the assets are traded under unique symbols.

A married put trading strategy comprises a simultaneous purchase of a stock and a put option on the stock for an equal amount of shares. This strategy has the effect of protecting an investor from downward movement in the stock while retaining upside potential. A covered write trading strategy is the selling of a call option while owning at least an equal amount of shares of the underlying stock. This strategy has the effect of providing the investor with a cash premium, but limits the investor's total potential profit while lowering investment cost. These are just two examples of the financial trading strategies involving equities and equity options the apparatus links into a package of instruments. The embodiments of the present invention herein can be used to implement any existing or newly developed trading strategies involving linked (or embedded) instruments. Moreover, by enabling simple quoting and trading of linked instruments, the present invention will enable the development of more complex linked trading strategies.

Investors who desire to implement these trading strategies buy or sell the individual assets, called legs. Current market systems do not provide a method whereby an investor can acquire all legs of a strategy involving both instruments (e.g. equities and equity options) through a single order. Currently, the investor must price, quote and acquire each leg individually, which exposes the investor to risk due to market volatility. For example, an investor may price and quote, or trade one leg of the strategy only to find that the market has moved away from the desired price range of the other leg. The failure to acquire all legs of the strategy can place the investor in a situation of open-ended risk.

The present invention alleviates this risk by linking the legs of a strategy together, providing an aggregated price, disseminating the quote of the combined assets, and providing an apparatus for trading the linked-assets almost simultaneously. The trading apparatus ensures that an investor either acquires all legs of the strategy or none at all. The apparatus, through this assurance, moves the risk away from the investor.

The methodology and apparatus of the present invention for the linking of assets (e.g., a quote apparatus) provides for the selection of specific assets (e.g., equities and equity option series), aggregated pricing, identifying market symbols, and dissemination of the aggregated price and symbol (e.g., a quote) to market participants. The apparatus consists of a real-time software system. The software system may be operated as part of a trading exchange, as a facility to a trading exchange, or independently. The system is connected via standard network communication lines for the purposes of subscribing to real time market quotes of the assets, for example, both equities and options, and the distribution of generated quotes for the linked assets.

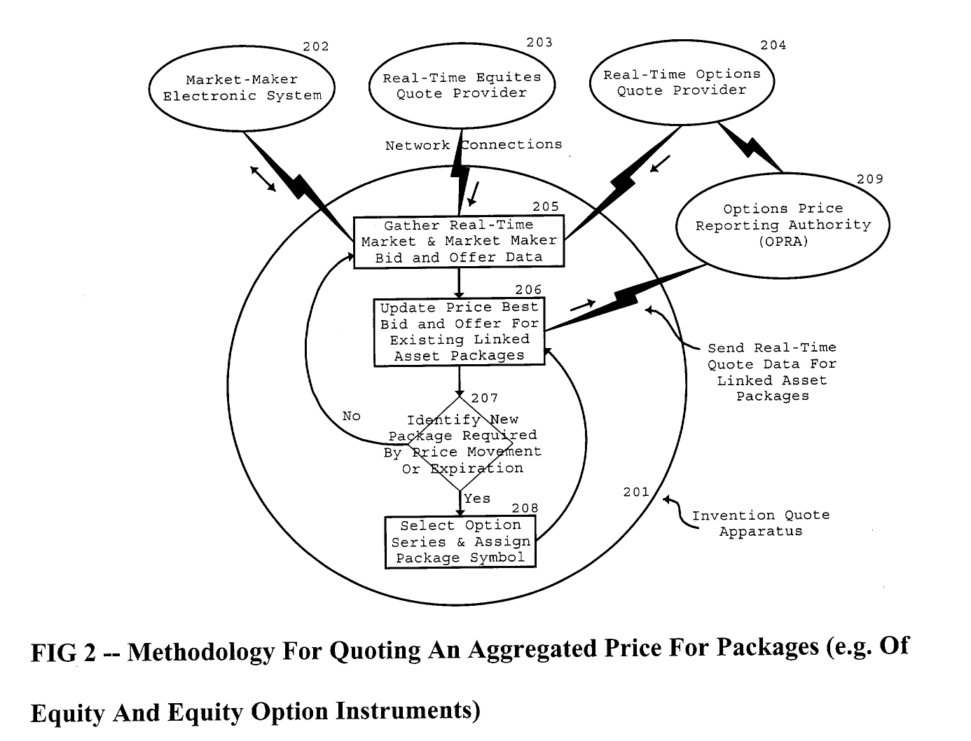

Referring to FIG. 2, shown therein is a block diagram of an exemplary embodiment of a process for developing quotes for linked assets according to one aspect of the present invention. The quote apparatus 201 subscribes to real-time equities market data 203 and real-time options market data 204. The quote apparatus is also connected via standard network communications to market makers for the linked assets 202. The quote apparatus continuously loops through real-time market data updating quotes for existing linked asset packages 206 and identifying situations that allow for the creation of new linked asset packages 207.

The rules for creating and maintaining linked asset packages include:

1. Only a subset of existing assets is available through linked asset packages. The makeup of the subset is determined by business considerations.

2. At the introduction of a new cycle (e.g., an equity option cycle) at least two linked asset packages are created for each asset (e.g., the underlying equity that the options is derived from) in the subset. One package represents the first out-of-the-money instrument (e.g., an option series) whose premium is less than a specified percentage of the underlying instrument's (e.g., the equity) price. The specific percentage is determined by business considerations. The second package is the next out-of-the-money option series after the one selected for the first package. Additional packages then follow this process.

3. When a package is created, the package is assigned a symbol 208 that may be, for example, the option symbol with the addition of alphabetical characters that represent the strategy.

4. Once a package has been created, the package is maintained until the expiration of the option leg of the package.

5. The price of the package is developed from the better bids and offers of either the national best bid and offer (NBBO) 203, 204 or bid and offer supplied by a participating market maker for the package 202.

6. New packages must be created when the underlying asset's (e.g., the equity) price moves through price levels that render existing linked asset packages in the money or too far out of the money. At all times there must be at least two linked asset packages that meet parameter #2 above.

Linked asset packages created and maintained by the quote apparatus are then disseminated to the marketplace through new or existing quote distribution channels 209, such as the Options Price Reporting Authority (OPRA) and real time equities quote providers.

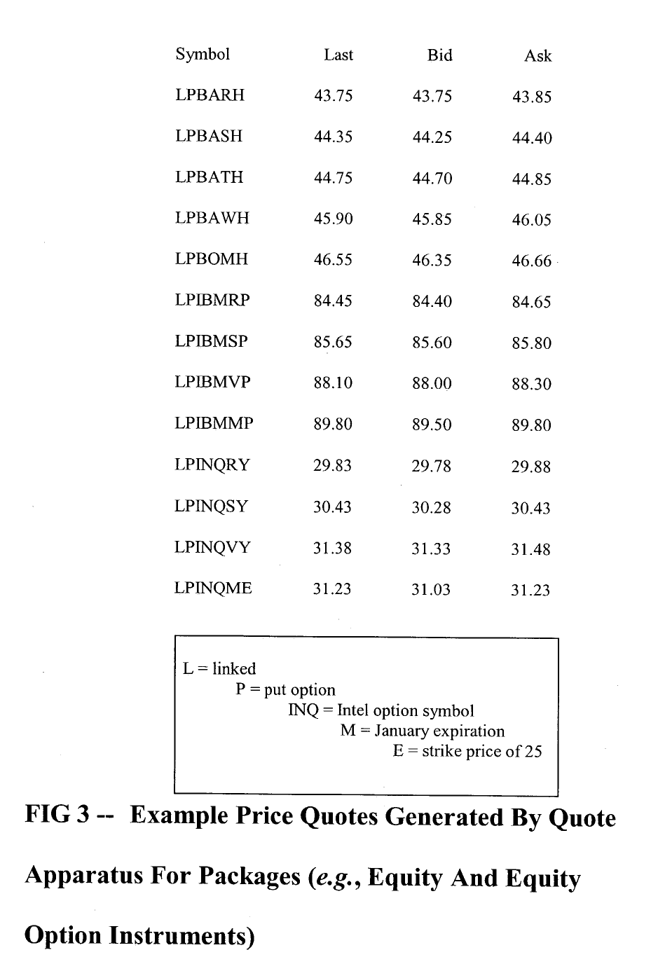

Turning to FIG. 3, shown therein is an exemplary embodiment of a sample of a quote stream disseminated by the quote apparatus, according to one aspect of the present invention. Any market participant that subscribes to real-time market data can receive linked asset quotes disseminated by the quote apparatus 209. Each symbol is comprised of elements of the trading strategy, the underlying equity, a price and a related derivative. For example, an L at the beginning indicates the quote relates to a linked product. Embedded within the symbol is the symbol for the underlying asset, e.g., IBM. Also embedded within the symbol is an indicator as to the type of derivative, such as “P” for a put option. Additionally, the expiration of the derivative is indicated as well. For example, an option that expires in January is so indicated by inclusion of the letter “M” in the symbol. Still, another indicator relates to the strike price of the derivative, such as E indicating a strike price of $25. When combined, the total linked product symbol will be, for example, LPINQME, thereby indicating the related product is a linked product of an Intel (INQ) equity, a put option (P) on an Intel equity, which has an expiration of January (M) and a strike price of $25.00 (E). In FIG. 3, the other symbols R, S, T, V, W, H and Y represent examples of other months and other strike prices.

Methodology for Investor Trading and Tracking

As a result of the present invention, investors can buy, sell, and track linked asset packages in the same way they would trade individual assets (e.g., equity or option assets). They contact their broker by either electronic or telephone communication and place buy or sell orders for linked asset packages. The following trading rules apply to the buying and selling of linked asset packages:

1. Investors buy or sell whole packages through a single order utilizing the linked asset package symbol.

2. Products are traded in equivalent share lots.

3. Orders may carry certain qualifications and instructions: (e.g., all or none (AON), fill or kill (FOK), immediate or cancel (10C), market, limit, etc.)

4. Once the package is owned, the owned package can be split into its individual assets and subsequently traded separately. Broker and regulatory rules and conditions concerning margins and other factors may apply.

5. Linked asset packages remain linked within an investor's account until sale of the package, expiration of the derivative, or until the package is explicitly separated into its individual component assets.

6. An investor can continue the linked asset strategy beyond the expiration of the original derivative series through other combinations, such as, for example, put or call spreads described below.

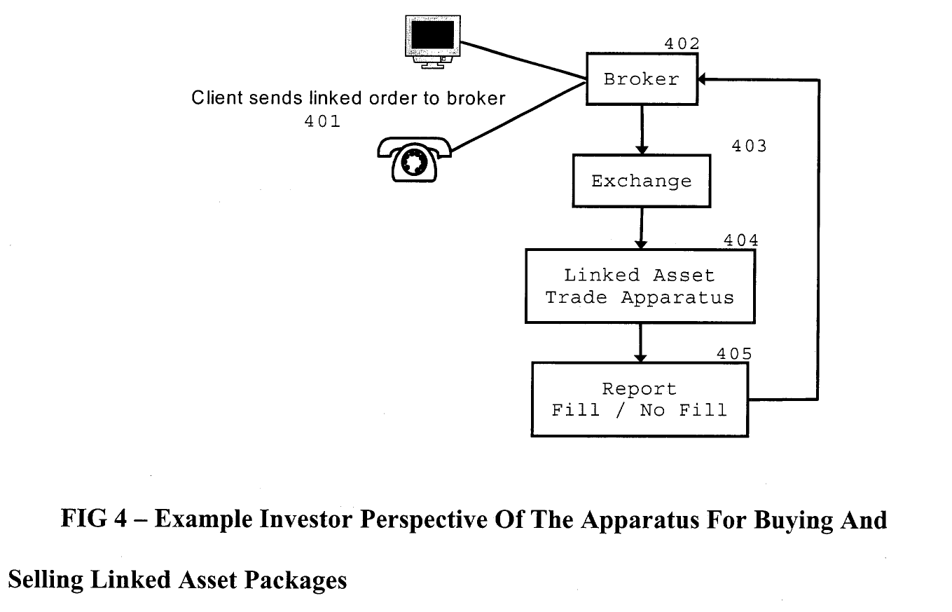

Turning to FIG. 4, shown therein is a block diagram of an exemplary embodiment of a process for buying and selling linked asset packages from the perspective of the investor. An investor 401 places a buy order or a sell order for a linked asset through a broker 402. The broker 402 sends the order to where the assets are traded (e.g., an exchange) 403 where the automated broker apparatus 404 attempts execution of the order. The automated broker apparatus 405 sends a trade report back to the broker 402 who notifies the investor 401.

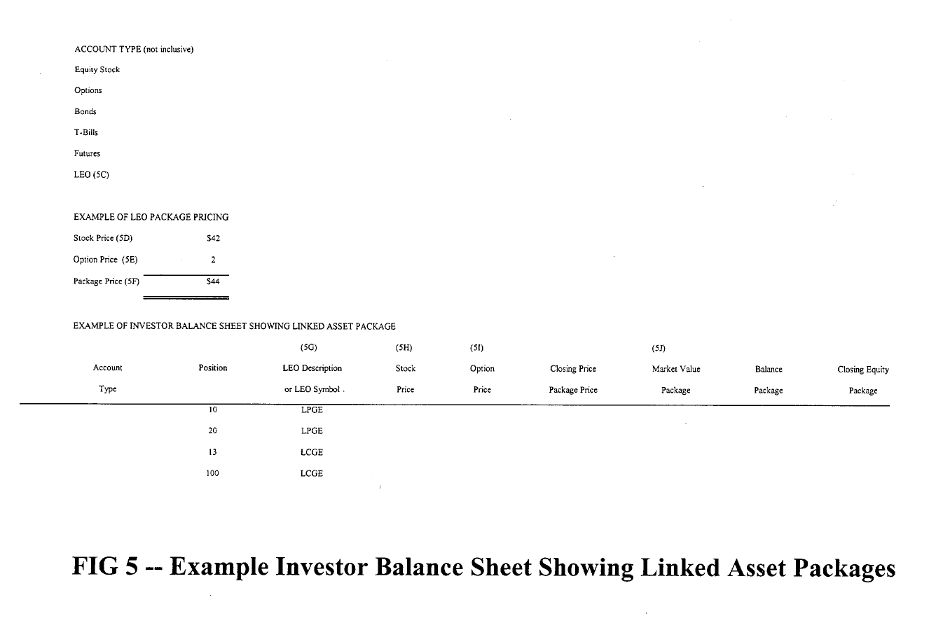

Refer to FIG. 5 for an example investor balance sheet showing linked assets. A separate category 5c displays linked assets 5d, 5e. The current market price 5f for the linked asset is displayed. The underlying stock symbol 5g and market price 5h as well as the option series 5i and market price 5j are displayed for reference. The investor is thus able to track the performance of a linked asset package in much the same way they can track the performance of individual assets.

As mentioned previously, owners of linked asset packages may split the packages into the individual assets and trade those individual assets on the open market in the ordinary manner. The individual assets may be fungible and therefore would have inherent liquidity in the open market subject to open interest. Brokers may elect to allow the trading of linked assets by investors who have not been authorized to trade the derivative separately (e.g., where a customer has not signed an options contract with his or her broker). This situation exists because linked asset packages of limited risk can be offered without concern that an investor will expose themselves to situations of open-ended risk. However, if an investor chooses to split the linked asset package, the broker may force the investor to close any open positions if the investor is not qualified to trade the derivative alone.

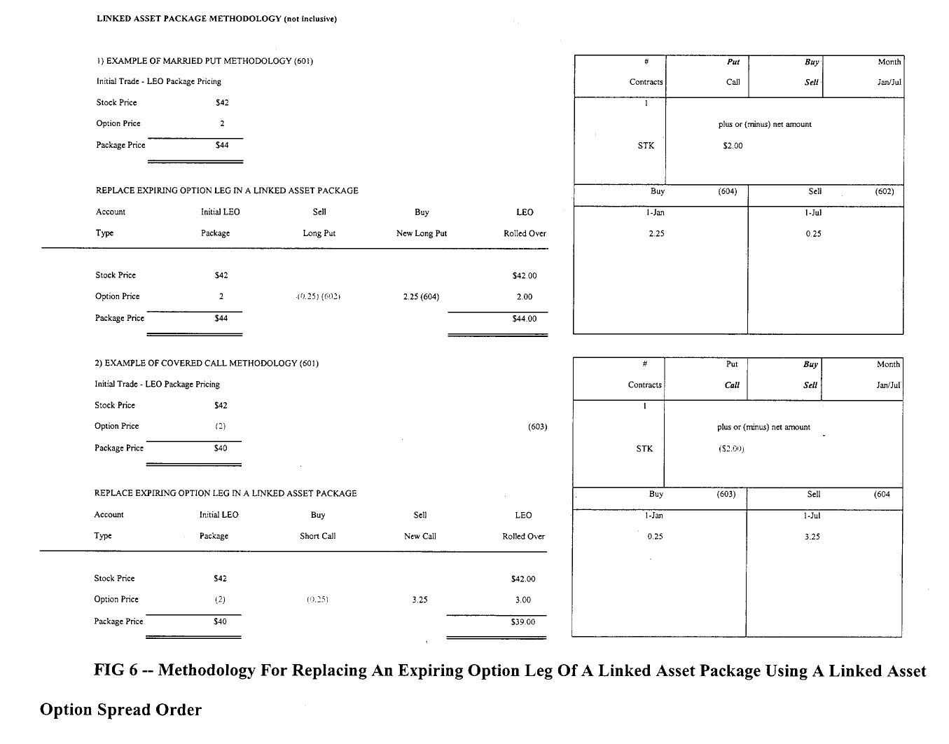

As legs of linked asset packages reach expiration, investors have the option of allowing the derivative leg to expire or to replace the expiring derivative series with a new derivative series for the same underlying asset. Refer to FIG. 6 for a diagram of an example of the process for replacing the option series utilizing a linked asset spread order. The investor 601 chooses a new option series 604 from the available option series 603 represented by existing linked asset packages for the specific underlying equity. The investor 601 then places an order 606 for the desired spread. This includes placing an order to close the expiring option and placing an order to open the new selection option. The simultaneous selling of the expiring option 602 with the purchase of the new option 604 maintains the integrity of the strategy the linked asset package is intended to represent. The use of symbols will maintain linkage within the clients account.

Method and Apparatus for Trading Linked Assets

Trading on an options exchange requires, at a minimum, the involvement of these participants:
Exchange: a market where instruments of investment such as equities, options, securities, commodities, and futures are traded;
Market Maker: member or affiliate of an exchange who increases liquidity in specific classes of options and makes competitive bids and offers;
Floor Broker: acts as an agent in the handling of public orders and can represent both the buyer and the seller in crossing trades on an external or local exchange trading platform;
Investor: public customer, firm, or market maker who takes a position on one side of a trade as either the buyer or the seller; and
Broker: a firm or individual who executes buy and sell orders submitted by investors.

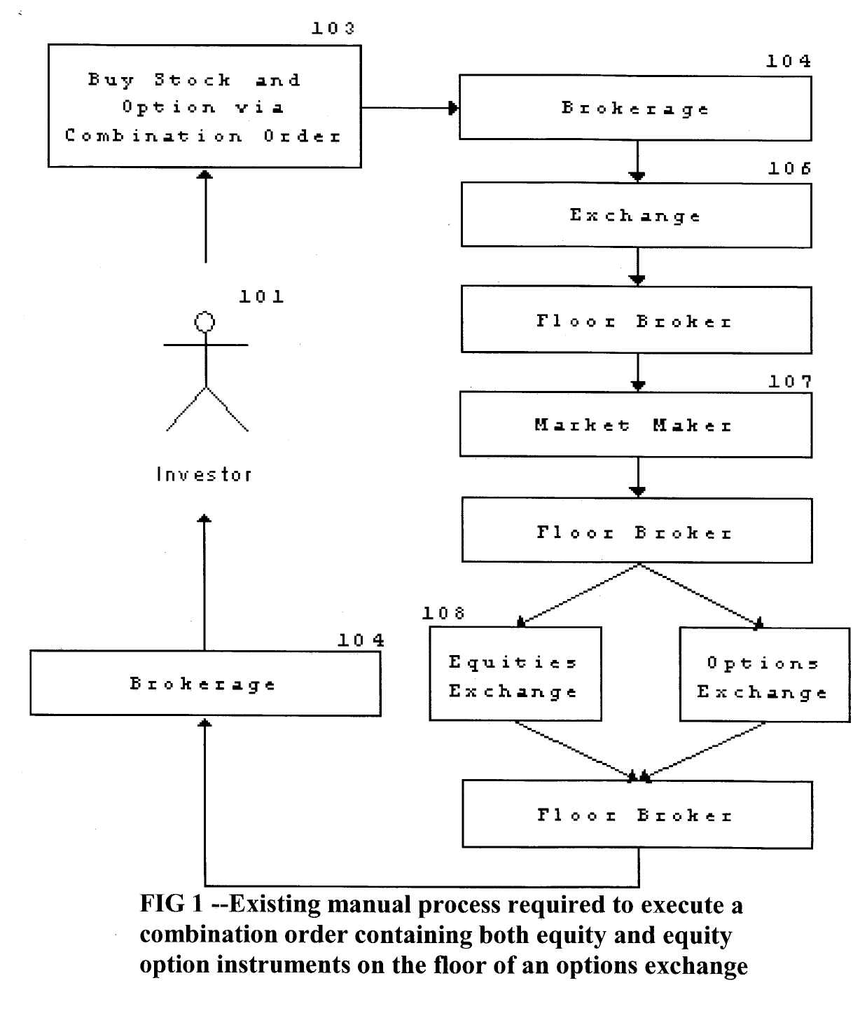

Refer to FIG. 1 for the traditional process of handling combination orders involving equity and equity option legs on the floor of an options exchange. These combination orders are orders for multiple assets 103 made by an investor 101 to a broker 104. The broker attempts to trade the assets 106 as described by the combination order. The broker represents the investor in the appropriate pit 107 and may also represent both the investor and a market maker in the crossing of an equities order on an external equities exchange 108. The broker reports 110 to the investor the result of the combination order.

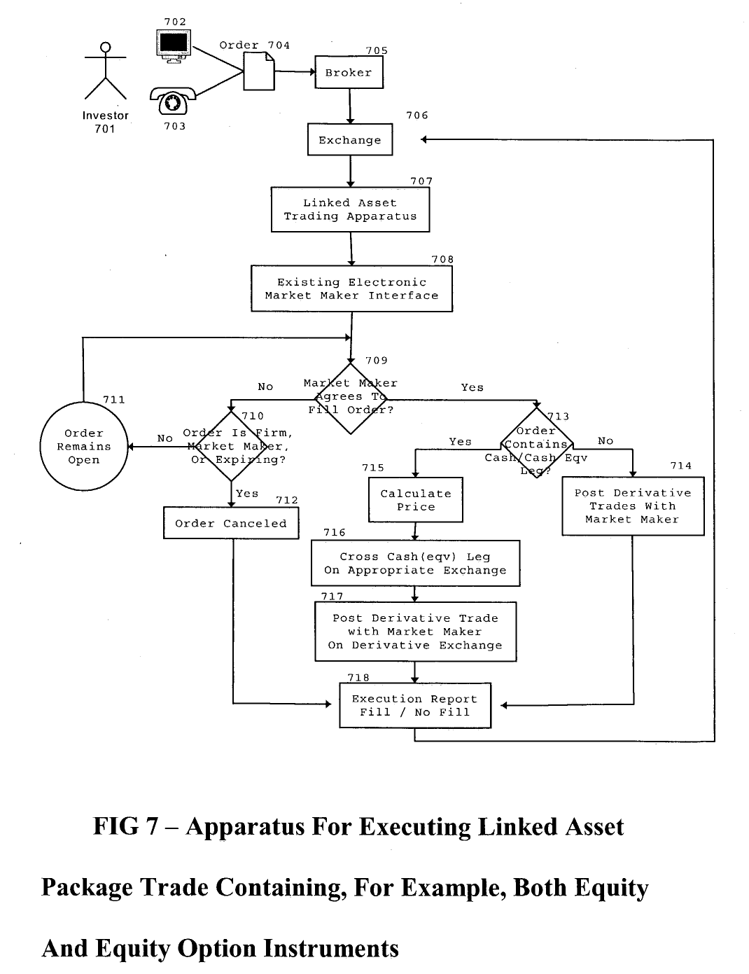

The method and apparatus for trading linked assets follows and improves upon the manual process for trading combination orders. Refer to FIG. 7 for the process diagram of the linked asset trading apparatus. An investor 701 places an order 704 for a linked asset with their broker 705. The investor can place the order either electronically 702 or by voice using a phone 703 for example. The broker 705 routes the order to an exchange 706 (in general, this can be any venue that performs trades, including upstairs traders, which are still part of an exchange) where the trading apparatus 707 is operating. The trading apparatus converts the linked asset into separate orders for equities and equity options. These separate orders constitute all legs of the linked asset package. The trading apparatus 707 begins the process to find an electronic match with the lead market maker 708 using an existing electronic interface to the market maker. The lead market maker, through existing systems, sets parameters that allow for automated electronic filling of an order. If a match is not found (709), if the order is firm, the market maker is firm or the order is expiring, then the order is cancelled 712 and a trade report is generated 718. If not, then the order remains open 711.

When a successful match is found the trading apparatus 707 calculates the price 715, and crosses the equity leg, if one exists, on an appropriate equities exchange 716. The trading apparatus 707 then posts all option leg trades with the market maker, for example, on the options exchange 717. Finally the trading apparatus generates a trade report 718 and sends the report back to the broker 705 and/or exchange 706. Thus, even if the SEC restrictions (mentioned in the Background) did not apply and a broker could trade the separate legs at one location, the present invention improves upon that by providing for multiple bids and offers to be calculated in one process for a combination order, thus ensuring that the best bid and offer are found for each leg.

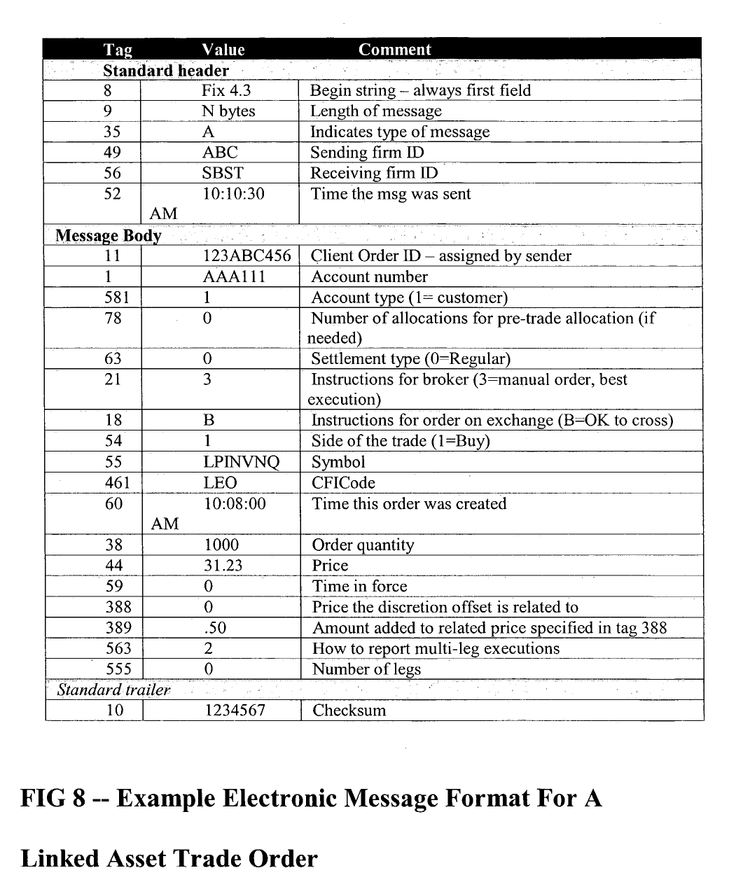

The trading apparatus consists of software operating partly in place of, for example, a floor broker on an options exchange. The apparatus operates on stand-alone hardware connected via standard communication networks to the trading environment (e.g., an options exchange) systems. The trading apparatus communicates with the exchange following the standard protocol (e.g., used by hand held devices or by the FIX standard for data communication on an options exchange). Refer to FIG. 8 for an example of a linked asset order in FIX format. The trading apparatus also connects via standard network communications (for example, on the floor of the exchange with remote equities exchanges). The trading apparatus communicates with the remote exchanges via standard formats such as, for example, the FIX format for sending orders when trading stocks and options.

There are three embodiments of buy and sell orders for linked asset packages sent to the trading apparatus. Embodiments 1 and 2 pertain to linked asset packages containing both the asset and its derivative (e.g., equities and equity option assets). Embodiment 3 pertains to linked asset packages containing only the derivative (equity option) assets.

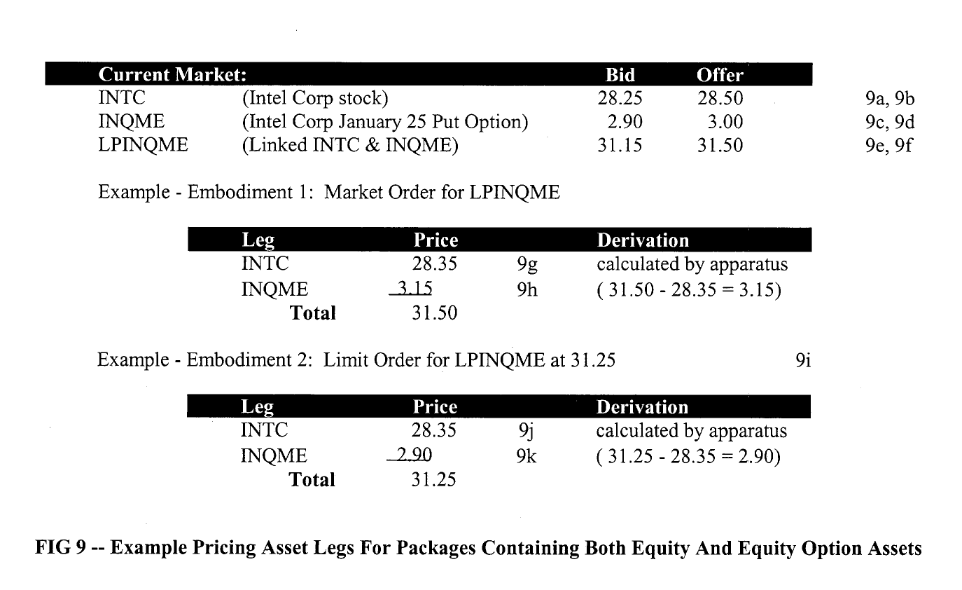

Embodiments 1 and 2 pertain to a linked asset trade containing both (e.g., equity and equity option) assets. Embodiment 1 describes the pricing of the (e.g., equity and option) legs of the trade for a market order. Embodiment 2 describes the pricing of the legs (e.g., equity and option legs) of the trade for a limit order. Refer to FIG. 9 for an example of the pricing of market and limit orders for embodiments 1 and 2.

For both embodiments 1 and 2 the trading apparatus performs price discovery on the underlying asset (e.g., equity leg) of the order by checking the current best market, or national best bid and offer (NBBO) 9a, 9b on all remote trading places (e.g., equities exchanges). The trading apparatus calculates a price 9g, 9j at which the underlying asset (e.g., equities order) can be crossed on an external exchange between the investor and the market maker who has accepted the order. To cross the asset in this manner requires that the asset price must be at or better than the NBBO, and within the current rules for trading of the instruments (e.g., rules for crossing stock on a stock exchange). The apparatus calculates a price at or better than the NBBO and, depending upon crossing rules in place at the time, may not match with existing orders that are waiting to be executed, for example, orders that reside in the book on an options or stock exchange floor. For example, if the equities best bid and offer is 54.00 to 54.50 the apparatus might calculate the cross order price to be 54.15. The apparatus then sends the cross-order to the equities exchange representing both the investor and the market maker who approved the trade.

The first embodiment pertains to the calculation of the derivative (e.g., option) price following the calculation of the underlying asset (e.g., equity) price for a market order. The trading apparatus calculates the price of the derivative (e.g., option) 9h to be the difference between the current market price 9f for the linked asset package and the price of the underlying asset (e.g., equities) crossed on the underlying asset trading location (e.g., equities exchange) 9g. For example if the linked asset package was quoted as trading at 57.25 to 57.50 and the price of the equities leg was calculated to be 54.15, then the price of the option would be 3.35 (57.50−54.15=3.35). The trading apparatus then posts the derivative (e.g., options) trade between the investor and the market maker at that price on the derivatives (e.g., options) exchange.

The second embodiment pertains to the calculation of the derivative price following the calculation of the underlying asset price for a limit order. In this example, using stock and options, the trading apparatus calculates the price of the option 9k to be the difference between the limit order price 9i for the linked asset package and the price of the equities asset crossed on the equities exchange 9j. For example if the limit order was accepted by the market maker at a price of 57.25 and the price of the equities leg was calculated to be 54.15, then the price of the option would be 3.10 (57.25−54.15=3.10). The trading apparatus then posts the options trade between the investor and the market maker at that price on the options exchange.

Embodiment 3 pertains to the trading of a linked asset trade containing only the derivative (e.g., equity option) assets. For example, the trading apparatus allows limit and market order trades where a limit may be placed on any of the option legs. The apparatus presents the combination order to the lead market maker through existing electronic systems on the floor of the options exchange. If the lead market maker or any market maker in the crowd accepts the trade, the prices of the legs will be set by the BBO on the offer for market orders and on the limit price for limit orders. The apparatus then posts the options trade on the options exchange representing both the investor and the market maker who approved the trade.

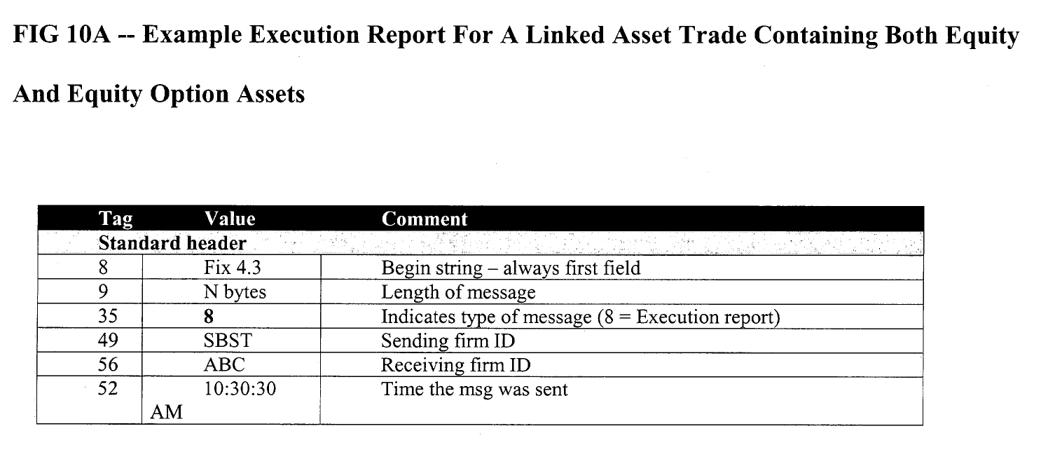

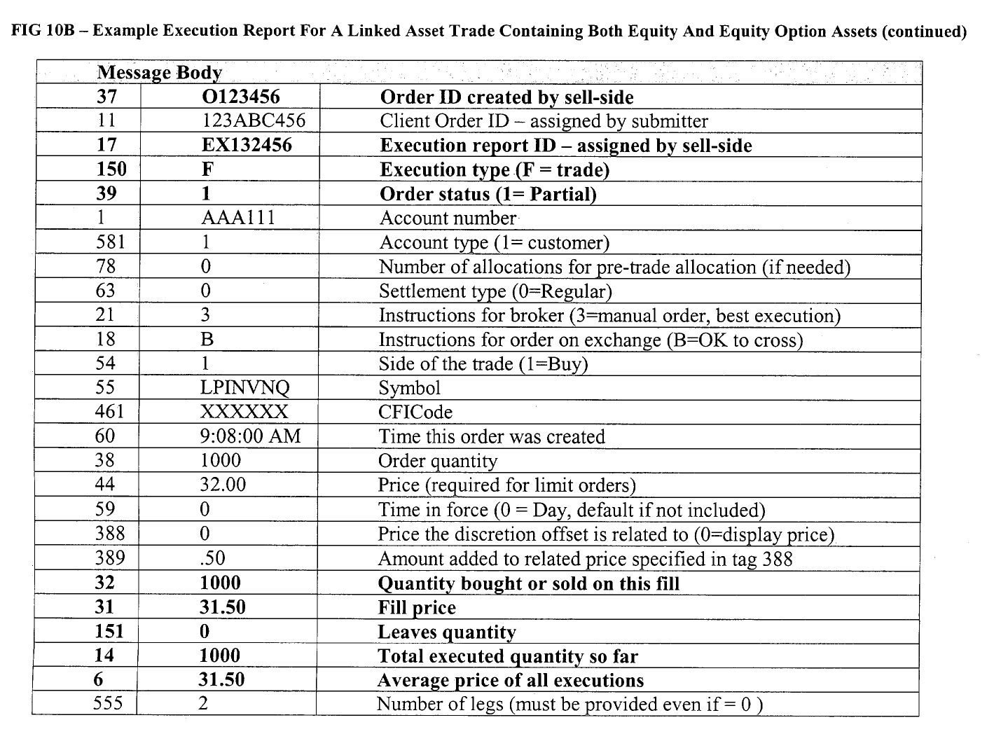

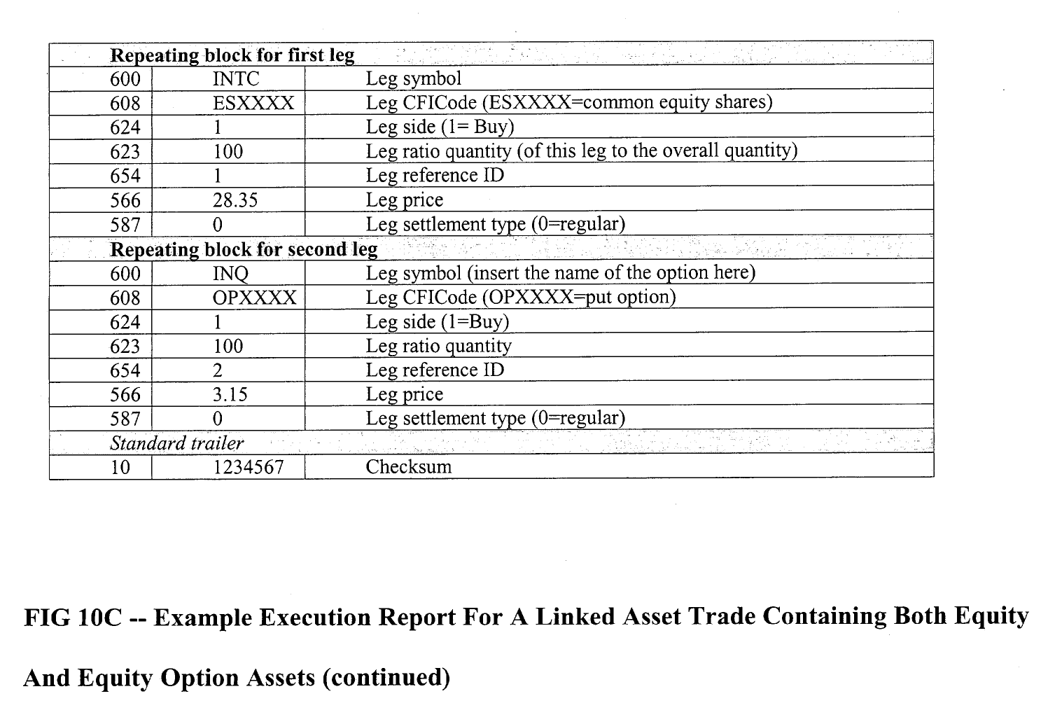

The trading apparatus collects the individual execution reports from both asset trades (e.g., equities cross trades and option post trades) as the agent for the investor. The apparatus then integrates the execution reports into a single execution report and sends the report to the originating broker by way of the existing network used for trading and reporting systems. Refer to FIG. 10 for an example of an execution report in FIX format for linked asset trades containing both equities and equity options. Refer to FIG. 7 for the block diagram showing the path of the execution report 718 from the apparatus to the exchange 706 to the broker 705 who posts the linked assets in the investor's 701 account.

Prior to, or at the end of a trading session the trading apparatus sends electronic notifications for all underlying assets (e.g., equities trades to the National Securities Clearing Corporation (NSCC)) for clearing and settlement. The derivative trading location or exchange sends reports of all derivative trades, for example, options trades to the Options Clearing Corporation (OCC), at the time of the trade throughout the trading session.

An exemplary embodiment of the present invention includes a computer system executing a method of matching and quoting of separate trading instruments that, when packaged together, creates a linked trading product that eliminates the need for actual side-by-side trading of the separate instruments. This process includes one or more of the following:
tracking electronically separate but related trading instruments;
searching electronically for the best bid and offer of each separate trading instrument;
selecting electronically a subset of available derivative (e.g., option series) based on liquidity, pricing, and time to expiration;
combining electronically existing underlying asset bids and offers with existing related derivative bid and offers, into one bid price and one offer price for the combined instruments;
assigning electronically quote symbols to the package of combined instruments;
disseminating electronically a combined bid and offer price for the combined instruments as a quote to the appropriate electronic quote dissemination service for distributing quotes to the public;
receiving electronically orders pertaining to the combined instrument quotes;
unlinking electronically the combined order into separate bids and offers for the separate trading instruments that make up the combined order;
disseminating the separated bids and offers to the electronic broker for representation of each order to the two separate markets or integrated market makers having the best bid and offer for each separate instrument, for execution;
receiving the executed trade information from the electronic broker;
recombining the separate executions into a trade report for the combined instruments;
disseminating the combined trade report to the electronic broker, for further dissemination to the customer that entered the combined order;
disseminating the combined trade report to the appropriate clearing corporations;
disseminating the combined trade report to the appropriate clearing corporations; and
disseminating electronically the assigned quote, which contains a color coded system to differentiate between participating market makers, the NBBO, the customer orders, and includes an explanation of the color system to show that one color represents a guaranteed market of a certain amount of assets from the participating market makers, where one color represents the NBBO, and one color represents customer orders added to the system.

Although various embodiments are specifically illustrated and described it will be appreciated that modifications and variations of the invention are by the above teachings and are within the purview of the appended claims departing from the spirit and intended scope of the invention. Furthermore, these s should not be interpreted to limit the modifications and variations of the on covered by the claims but are merely illustrative of possible variations.

1. A method for trading one or more instruments comprising:
combining a plurality of existing bids and offers for an asset with a plurality of bids and offers for a related derivative instrument, into a single bid price and a single offer price for a combined instrument, which includes the asset and the related derivative instrument;
disseminating the single bid price and the single offer price as a quote for the combined instrument;
receiving a linked order to trade a linked instrument, which linked order includes a cash or cash equivalent instrument combined with a derivative instrument;
converting automatically the linked order to an order to trade the cash or cash equivalent instrument and an order to trade the derivative instrument;
attempting to match the order to trade the cash or cash equivalent instrument with a market maker in the cash or cash equivalent instrument;
obtaining a commitment from a market maker in the derivative instrument market to match the derivative instrument as a part of, and in connection with, the trading of the cash or cash equivalent instrument; and
crossing the order to trade cash or cash equivalent instrument on an exchange, if a successful match is identified.

2. The method according to claim 1, further comprising routing electronically the linked order to a linked trading system.

3. The method according to claim 1, further comprising posting a trade involving the order to trade the derivative instrument on a derivative exchange if a successful cross of the cash or cash equivalent instrument has occurred and an appropriate derivative instrument match is identified.

4. The method according to claim 1, further comprising sending a trade report to a broker that sent the linked order.

5. The method according to claim 1, further comprising disseminating a quote for each of one or more linked instruments, which quote includes a combination of a trading symbol of the cash or cash equivalent instrument, a trading strategy of the linked instrument and a price for the linked instrument.

6. A method for creating a market in one or more linked instruments, each of which includes an equity based instrument and an option based instrument, which option based instrument is derived from said equity based instrument, said method comprising:
creating at a predetermined time at least two linked instruments for each equity based instrument, wherein a first linked instrument represents a first out-of-the-money option series whose premium is less than a predetermined percentage of a price of the equity based instrument, and the second package represents a next out-of-the-money option series after the first out-of-the-money options series selected for the first linked instrument;
assigning to each linked instrument created a trading symbol that is a combination of a trading symbol for the equity based instrument and one or more additional characters indicative of a relationship of the option based instrument to the equity based instrument;
maintaining each of the at least two linked instruments until expiration of the option based instrument in said each of the at least two linked instruments.

7. The method according to claim 6, further comprising developing a price for each of the at least two linked instruments from a better bid and offer of either: (1) a national best bid and offer for the equity based instrument and a national best bid and offer for the option based instrument in each of the at least two linked instruments; or (2) a bid and offer supplied by a participating market maker for said each linked instrument.

8. The method according to claim 6, further comprising creating a new linked instrument when a price of the equity based instrument moves through a price level that renders an existing linked instrument in-the-money or beyond a predetermined value out-of-the-money so that at all times at least two linked instruments are maintained.

9. The method according to claim 6, further comprising disseminating a quote for each of the at least two linked instruments created and maintained.

10. A method for distributing quotes for linked instruments, which include an asset and a derivative instrument related to the asset, said method comprising:
disseminating a quote stream that includes real-time market data regarding the linked instruments; and
including in each quote a symbol comprised of elements of a trading strategy, the asset, the derivative instrument and a price for the linked instrument.

11. The method according to claim 10, further comprising developing a price for each of the linked instruments from a better bid and offer of either: (1) a national best bid and offer for the asset and a national best bid and offer for the derivative instrument in each of the linked instruments; or (2) a bid and offer supplied by a participating market maker for said each linked instrument

12. An electronic trading method comprising:
combining a plurality of existing bids and offers for an asset with a plurality of bids and offers for a related derivative instrument, into a single bid price and a single offer price for a combined instrument, which includes the asset and the related derivative instrument;
assigning a quote symbol to the combined instrument; and
disseminating the single bid price and the single offer price for the combined instrument as a quote to an electronic quote dissemination service for distributing quotes to the public.

13. The method according to claim 12, further comprising receiving electronically one or more trading orders for the combined instrument.

14. The method according to claim 13, further comprising unlinking electronically each of the one or more combined orders into a separate bid and offer for each of the asset and the derivative instrument that make up the combined instrument.

15. The method according to claim 14, further comprising disseminating the separate bids and offers to an electronic broker for representation of each order to two separate markets or to an integrated market maker having a best bid and offer for each separate instrument, for execution.

16. The method according to claim 15, further comprising receiving executed trade information from the electronic broker and recombining each received separate execution into a single trade report for the combined instrument.

17. The method according to claim 16, further comprising disseminating the single trade report for the combined instrument to the electronic broker, for further dissemination to the customer that entered the combined order.

18. The method according to claim 16, further comprising disseminating the single trade report for the combined instrument to one or more appropriate clearing corporations.

19. The method according to claim 16, disseminating electronically an assigned quote that contains a color coded system to differentiate between a participating market maker, a NBBO, and a customer order.

20. The method according to claim 19, wherein the assigned quote includes an explanation of the color coded system to show that one color represents a guaranteed market of a certain amount of assets from the participating market makers, one color represents the NBBO, and one color represents customer orders added to the system.

21. The method according to claim 12, further comprising tracking electronically a plurality of separate but related trading instruments.

22. The method according to claim 21, further comprising searching electronically for a best bid and offer for each of the plurality of separate but related trading instruments.

23. The method according to claim 22, further comprising selecting electronically a subset of available derivative instruments based on predetermined criteria involving liquidity, pricing and time to expiration.

24. A method for replacing an option series in a linked asset package that includes an underlying equity and an option series on the underlying equity, said method comprising:
selecting a new option series from one or more available option series represented by one or more existing linked asset packages for the underlying equity;
placing a linked order for a desired spread, which linked order includes an order to close the expiring option and an order to open the new option series.

25. A method for creating a market in one or more linked instruments, each of which includes a cash or cash equivalent instrument and a derivative instrument, which derivative instrument is derived from said cash or cash equivalent instrument, said method comprising:
creating a linked instrument for each of a predetermined group of cash or cash equivalent instruments; and
assigning to each linked instrument created a trading symbol that is a combination of a trading symbol for the cash or cash equivalent instrument and one or more additional characters indicative of a strategy of the linked instrument.

26. The method according to claim 25, further comprising developing a price for each of the linked instruments from a better bid and offer of either: (1) a national best bid and offer for the cash or cash equivalent instrument and a national best bid and offer for the derivative instrument in each of the linked instruments; or (2) a bid and offer supplied by a participating market maker for said each linked instrument.

27. The method according to claim 26, further comprising creating a new linked instrument when a price of the cash or cash equivalent instrument moves through a price level that renders an existing linked instrument in-the-money or beyond a predetermined value out-of-the-money.

28. The method according to claim 25, further comprising disseminating a quote for each of the linked instruments created.
